(19) United States
(12) Patent Application Publication
(10) Pub. No.: US 2012/0017387 A1
(43) Pub. Date: Jan. 26, 2012

(54) Biodegradable Net-Shaped and Filament-Shaped Articles

(76) Inventors: Chien-Ming Huang, Taichung City (TW); Yu-Kai Huang, Taichung County (TW)

(21) Appl. No.: 12/840,701

(22) Filed: Jul. 21, 2010

(51) Int. Cl. A46D 1/00; B65D 30/02; A47K 7/02; A01D 34/00

(52) U.S. Cl. 15/207.2; 56/12.7; 383/1; 15/210.1; 442/1

(57) ABSTRACT

A biodegradable net-shaped article includes: a net structure made from a biodegradable plastic composition which includes a major component selected from polybutylene-1,4-succinate, polybutylene succinate adipate, and combinations thereof. A biodegradable filament-shaped article made from the biodegradable plastic composition is also disclosed.

### BACKGROUND OF THE INVENTION

1. Field the Invention

This invention relates to biodegradable net-shaped and filament-shaped articles made of polymer materials.

2. Description of the Related Art

A conventional net bag, which is one kind of net-shaped articles, is made of polymer materials capable of being easily processed and is formed by extruding and drawing the polymer materials to form a net sleeve, followed by heat sealing one end of the net sleeve to form the net bag with a closed end. The net bag has an open end, opposite to the closed end, for passage of goods. After the goods are received in the net bag, the open end may be tied or sealed to package the goods.

The net bag is mainly used for packaging the goods. Since the net bag is formed with pores for ventilation, the goods, especially agricultural products of vegetables or fruits, are unlikely to get rotten.

Although the net bag is formed with the pores for keeping the goods in a ventilated state, the net bag still has the following drawbacks.

Because the net bag is usually used for packaging the vegetables or the fruits, it is likely to be discarded after use. In order to form a net structure with a predetermined strength, the net bag is usually made of polyethylene (PE), polyethylene terephthalate (PET), or nylon. However, all of PE, PET and nylon are hard to decompose in natural environment and tend to cause environmental problems.

### SUMMARY OF THE INVENTION

Therefore, an object of the present invention is to provide biodegradable net-shaped and filament-shaped articles that are environment-friendly, and that can provide desired physical properties.

According to one aspect of the present invention, there is provided a biodegradable net-shaped article comprising: a net structure made from a biodegradable plastic composition which includes a major component selected from the group consisting of polybutylene-1,4-succinate, polybutylene succinate adipate, and combinations thereof.

According to another aspect of the present invention, there is provided a filament-shaped article comprising: a filament structure made from a biodegradable plastic composition which includes a major component selected from the group consisting of polybutylene-1,4-succinate, polybutylene succinate adipate, and combinations thereof.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of a preferred embodiment of the biodegradable net-shaped article according to the present invention, wherein the net-shaped article is in a form of a net bag;

FIG. 2 is a fragmentary enlarged view of the net bag of FIG. 1;

FIG. 3 is a schematic view of the net bag of FIG. 1 in a used state;

FIG. 4 is a schematic view of another preferred embodiment of the biodegradable net-shaped article according to the present invention, wherein the net-shaped article is in a form of a bathing ball net; and

FIG. 5 is a schematic view of yet another preferred embodiment of the biodegradable net-shaped article according to the present invention, wherein the net-shaped article is in a form of a drain strainer.

### DETAILED DESCRIPTION OF THE PREFERRED EMBODIMENTS

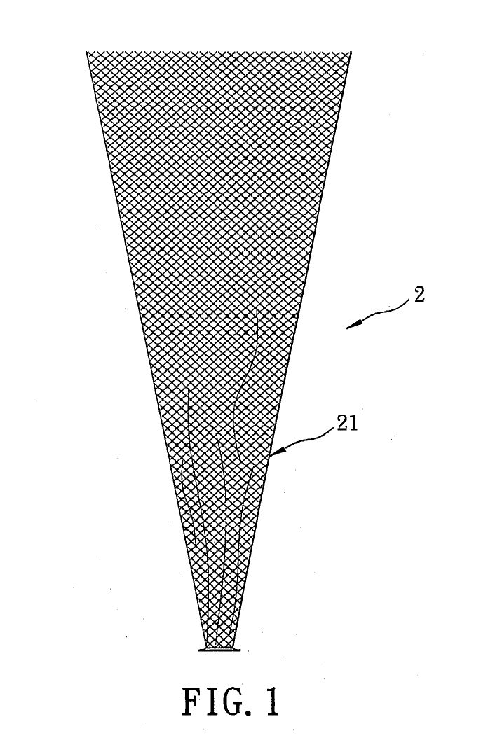

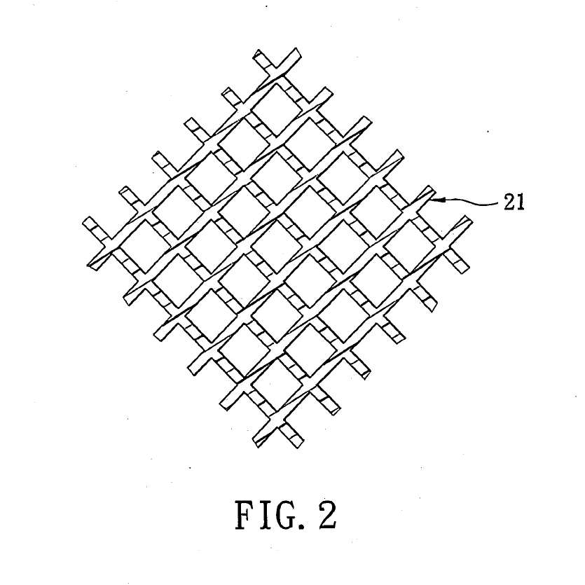

Referring to FIGS. 1 and 2, a biodegradable net-shaped article is formed as a net bag 2 according to the first preferred embodiment of the present invention. The net bag 2 includes a net structure 21.

The net structure 21 is manufactured by drawing a biodegradable plastic composition which includes a major component selected from the group consisting of polybutylene-1,4-succinate (PBS), polybutylene succinate adipate (PBSA), and combinations thereof. In this invention, since the net structure 21 may be made using a conventional method for fabricating the conventional net bag made of PE, PET or nylon, the detailed description thereof will be omitted herein.

Preferably, the biodegradable plastic composition further includes polylactic acid (PLA) in an amount of 0-30% by weight based on a total weight of the biodegradable plastic composition. Since a product made of PLA has a relatively large rigidity in room temperature, the rigidity and the dimensional stability of the net structure 21 in room temperature can be greatly improved by adding PLA to the biodegradable plastic composition.

Besides, the biodegradable plastic composition may further include a filler. Preferably, the filler is in an amount of 15-35 parts by weight based on 100 parts by weight of the biodegradable plastic composition. The filler is selected from the group consisting of calcium carbonate, mica, clay, a silicate, talc, and combinations thereof.

PBS has mechanical properties like that of linear low-density polyethylene (LLDPE) and better than those of other biodegradable plastic materials. Furthermore, PBS has a heat deflection temperature (HDT) of up to about 90° C. Besides, PBSA has a property close to that of low-density polyethylene (LDPE) such that a product made of PBSA can be provided with a relatively pliable property, and such that the net structure 21 can give a soft touch feeling and can be extended or expanded easily when an external force is applied to the net structure 21. Hence, PBS and PBSA can be easily processed into the net structure 21, and the mechanical strength and the tensile strength of the net structure 21 can be adjusted by controlling the amounts of PLA and the filler added to the major component so as to conform to the requirements for actual applications. Besides, since the net structure 21 is made of PBS or PBSA, or a mixture of PBS and PBSA as a major component, not only can it have improved durability due to a relatively good heat-resistance and improved resistance to deformation or breaking at a relatively high temperature, but the touch feeling thereof can be improved as well in addition to the environment-friendly biodegradation property.

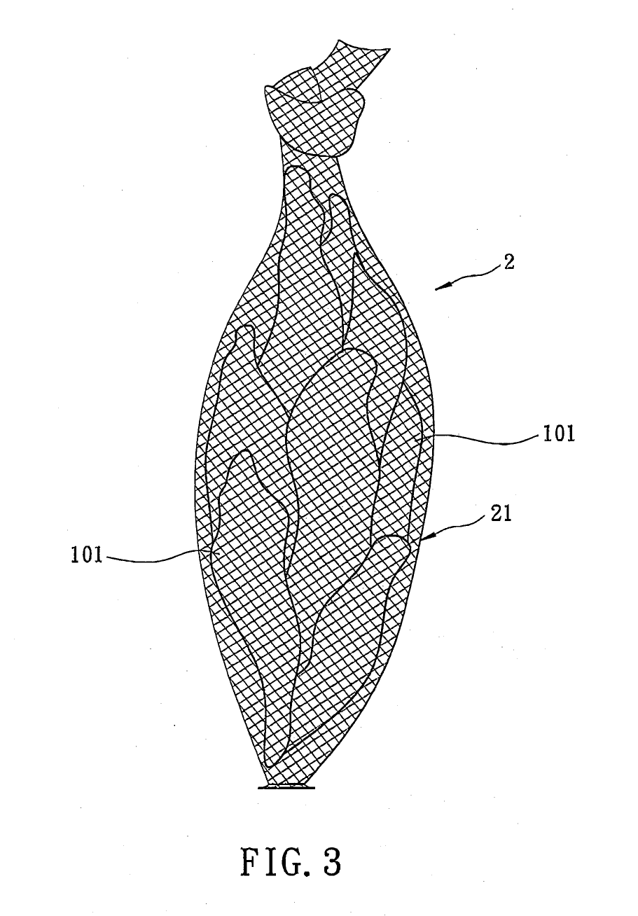

Of course, the application of the biodegradable net-shaped article is not limited to the net bag 2, and the biodegradable net-shaped article can be formed into any products according to the intended use, such as a bathing ball net, a drain strainer, a geogrid, etc. As shown in FIG. 3, the net bag 2 is used for packaging an agricultural product 101. However, the application of the net bag 2 should not be limited only to the packaging of the agricultural product 101, and can be used for receiving tennis ball(s), basketball(s), shoes, cup(s), etc.

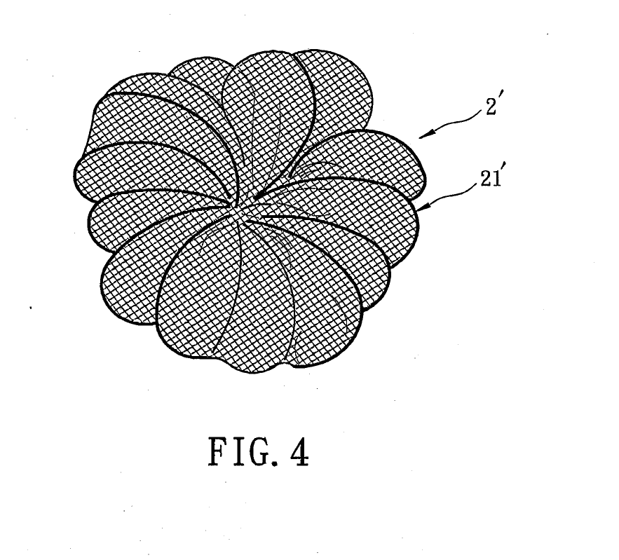

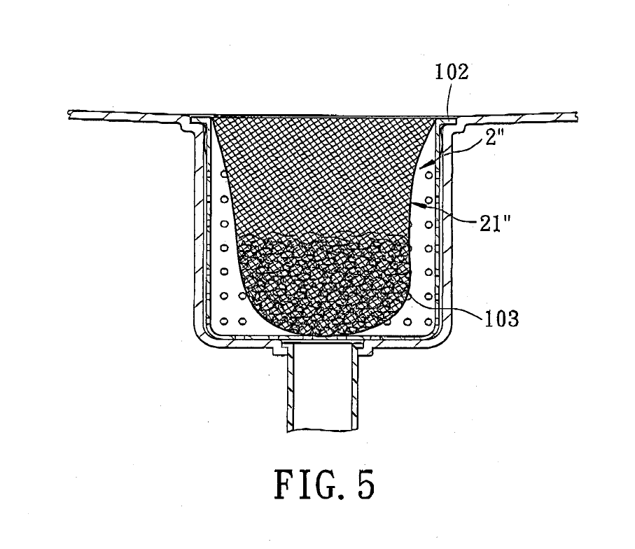

Referring to FIG. 4, the biodegradable net-shaped article has a net structure 21′ configured as a biodegradable bathing ball net 2′. Since the biodegradable bathing ball net includes PBS having a relatively high heat deflection temperature, it is unlikely to deform when it is brought into contact with shower water at a relatively high temperature. Referring to FIG. 5, the biodegradable net-shaped article has a net structure 21″ configured as a drain strainer 2″. In order to prevent a drain outlet from being clogged by food residue, the drain strainer 2″ is disposed in a sink strainer 102 for catching food residue. When the drain strainer 2″ is full of the food residue 103, the drain strainer 2″ and the food residue 103 caught thereby may be removed from the sink strainer 102.

Besides, when the biodegradable net-shaped article is configured as a geogrid, it may be used for reinforcing a slope land with poor vegetation to reduce soil erosion from a base of the land. After the vegetation of the slope land is formed completely and stably, the geogrid will degrade gradually in natural environment. Therefore, compared to a conventional geogrid, the geogrid made of the biodegradable plastic composition according to the present invention is environment-friendly and is not necessary to be removed from the slope land.

It should be noted that the biodegradable plastic composition may be processed to manufacture filaments with various diameters. The filaments may be applied to produce bristles of a brush, such as a toothbrush, or a filament cutter element for a mower.

### EXAMPLES

### Examples 1 to 10

### Preparation of Biodegradable Plastic Compositions

Examples 1 to 10 of biodegradable plastic compositions were prepared using the formulations shown in Table 1. PBS and PBSA are commercial products available from Mitsubishi Chemical Industries, Ltd. under trade names of GS pla AZ91 and GS pla AD92, respectively.

TABLE 1

Formulations

| | PBS | PBSA | PLA | Filler |
|---|---|---|---|---|
| | (parts by | (parts by | (parts by | (parts by |
| Ex. | weight) | weight) | weight) | weight) |
| 1 | 100 | 0 | 0 | 0 |
| 2 | 100 | 0 | 0 | 15 |
| 3 | 100 | 0 | 0 | 25 |
| 4 | 100 | 0 | 0 | 30 |
| 5 | 87 | 0 | 13 | 30 |
| 6 | 87 | 0 | 13 | 35 |
| 7 | 70 | 0 | 30 | 30 |
| 8 | 0 | 100 | 0 | 0 |
| 9 | 10 | 90 | 0 | 0 |
| 10 | 45 | 50 | 5 | 0 |

### Examples 11 to 20

Examples 11 to 20 are net-shaped specimens which were prepared respectively from the biodegradable plastic compositions of Examples 1-10. Table 2 shows the results of various tests conducted for the net-shaped specimens.

TABLE 2

| Test Item | Examples | | | | | | | | | |
|---|---|---|---|---|---|---|---|---|---|---|
| (Test method) | 11 | 12 | 13 | 14 | 15 | 16 | 17 | 18 | 19 | 20 |
| Melting Temp. | 110 | 110 | 110 | 110 | 145 | 145 | 145 | 86 | 89 | 89 |
| Density (g/cm³) | 1.26 | 1.33 | 1.36 | 1.36 | 1.44 | 1.5 | 1.38 | 1.24 | 1.24 | 1.25 |
| (ASTM D792) | | | | | | | | | | |
| Tensile | 69.07 | 54.38 | 53.30 | 51.08 | 56.43 | 37.09 | 46.72 | 54.75 | 60.88 | 87.73 |
| Strength | | | | | | | | | | |
| (Kgf/cm²) | | | | | | | | | | |
| (ASTM D638) | | | | | | | | | | |
| Elongation | 23 | 20 | 15 | 19 | 7.4 | 5.7 | 6.2 | 57 | 50 | 44 |
| Ratio (%) | | | | | | | | | | |
| (ASTM D638) | | | | | | | | | | |
| HDT (° C.) | 91.0 | 86.3 | 88.8 | 90.6 | 86.0 | 89.4 | 73.6 | 80 | 80 | 85 |
| (under load | | | | | | | | | | |
| of 66 psi) | | | | | | | | | | |
| (ASTM D648) | | | | | | | | | | |
| Melt Flow | 4.5 | 11.01 | 10.47 | 10.59 | 14.24 | 18.92 | 8.51 | 4.5 | 4.7 | 4.7 |
| Rate (190° C., | | | | | | | | | | |
| 2.16 kg) | | | | | | | | | | |
| (g/10 min) | | | | | | | | | | |
| (ASTM D1238) | | | | | | | | | | |
| Hardness | 73 | 78 | 83 | 85 | 88 | 93 | 89 | 65 | 67 | 67 |
| (Shore D) | | | | | | | | | | |
| (ASTM D785) | | | | | | | | | | |
| Color | white | white | white | white | white | white | white | white | white | white |

* HDT means heat deflection temperature

### Examples 21 to 30

Examples 21 to 30 are filament-shaped specimens which were made respectively from the plastic compositions of Examples 1 to 10. Table 3 shows the results of various tests for the filament-shaped specimens.

| Test Item | | Examples | | | | | | | | | |
|---|---|---|---|---|---|---|---|---|---|---|---|
| (Test method) | | 21 | 22 | 23 | 24 | 25 | 26 | 27 | 28 | 29 | 30 |
| Average diameter (mm) | | 1.98 | 1.98 | 1.97 | 1.97 | 1.97 | 1.97 | 1.97 | 1.98 | 1.98 | 1.98 |
| Color | | white | white | white | white | white | white | white | white | white | white |
| Denier | | 31432 | 33094 | 33841 | 33078 | 35832 | 36889 | 34383 | 31042 | 31453 | 31104 |
| Tensile Strength | Kg | 42.00 | 33.06 | 32.40 | 31.05 | 34.31 | 22.55 | 28.40 | 33.00 | 36.68 | 51.45 |
| (ASTM D2256) | g/D | 1.34 | 1.00 | 0.96 | 0.94 | 0.96 | 0.61 | 0.83 | 1.06 | 1.17 | 1.65 |

| | | | | | | | | | | |
|---|---|---|---|---|---|---|---|---|---|---|
| Elongation Ratio | 143 | 108 | 103 | 73 | 22 | 16 | 11 | 437 | 386 | 272 |
| (%) (ASTM D2256) | | | | | | | | | | |

* D means denier

With the biodegradable net-shaped and filament-shaped articles according to the present invention, not only are they suitable for use as safe, durable, and environment-friendly disposable articles, they can also provide a soft touch feeling and a required strength.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A biodegradable net-shaped article comprising:
a net structure made from a biodegradable plastic composition which includes a major component selected from the group consisting of polybutylene-1,4-succinate, polybutylene succinate adipate, and combinations thereof.

2. The biodegradable net-shaped article of claim 1, wherein said biodegradable plastic composition further includes polylactic acid in an amount of 0-30% by weight based on a total weight of the biodegradable plastic composition.

3. The biodegradable net-shaped article of claim 2, wherein said biodegradable plastic composition further includes a filler in an amount of 15-35 parts by weight based on 100 parts by weight of the biodegradable plastic composition, the filler being selected from the group consisting of calcium carbonate, mica, clay, a silicate, and talc.

4. The biodegradable net-shaped article of claim 1, wherein said biodegradable net-shaped article is a net bag.

5. The biodegradable net-shaped article of claim 1, wherein said biodegradable net-shaped article is a bathing ball net.

6. The biodegradable net-shaped article of claim 1, wherein said biodegradable net-shaped article is a geogrid.

7. A biodegradable filament-shaped article comprising: a filament structure made from a biodegradable plastic composition which includes a major component selected from the group consisting of polybutylene-1,4-succinate, polybutylene succinate adipate, and combinations thereof.

8. The biodegradable filament-shaped article of claim 7, wherein said biodegradable plastic composition further includes polylactic acid in an amount of 0-30% by weight based on a total weight of the biodegradable plastic composition.

9. The biodegradable filament-shaped article of claim 8, wherein said biodegradable plastic composition further includes a filler in an amount of 15-35 parts by weight based on 100 parts by weight of the biodegradable plastic composition, the filler being selected from the group consisting of calcium carbonate, mica, clay, a silicate, and talc.

10. The biodegradable filament-shaped article of claim 7, wherein said biodegradable filament-shaped article is a bristle of a brush.

11. The biodegradable filament-shaped article of claim 7, wherein said biodegradable filament-shaped article is a filament cutter element for a mower.
